(19) United States
(12) Patent Application Publication
(10) Pub. No.: US 2010/0045095 A1
(43) Pub. Date: Feb. 25, 2010

(54) Wheel for vehicles and method for producing the same

(75) Inventors: Junji Matsuo, Ikeda-shi (JP); Kiyoshi Amaki, Ikeda-shi (JP); Shoji Suzuki, Ikeda-shi (JP); Takashi Nishizaka, Ikeda-shi (JP)

Correspondence Address: Quinn Emanuel Urquhart Oliver & Hedges, LLP;Koda/Androlia, 865 S. Figueroa Street, 10th Floor, Los Angeles, CA, 90017, US

(73) Assignee: Zeniya Aluminum Engineering, Ltd.

(21) Appl. No.: 12/322,789

(22) Filed: Feb. 6, 2009

(30) Foreign Application Priority Data
Aug. 22, 2008 (JP) 2008-214005

(51) Int. Cl. B60B 19/00; B21K 1/38

(52) U.S. Cl. 301/5.1; 29/894.351

(57) ABSTRACT

A wheel for a vehicle including an outer rim and an inner rim, in which the outer rim is comprised of a disk section formed by embossing a first portion having a certain thickness and a rim section formed by drawing a second portion having a smaller thickness than the first portion so as to make a periphery of the disk section; and the inner rim is comprised of superimposed portions formed by drawing and to be superimposed on prescribed positions of the disk section of the outer rim. Flange sections of the outer and inner rims are respectively inwardly curled so as to form a double-layered structure. The outer and inner rims are integrated by welding with the superimposed portions set at the prescribed positions of the disk section.

### BACKGROUND OF THE INVENTION

1. Field of the Invention

The present invention relates to a wheel for a variety of vehicles including a vehicle capable of traveling in a place with any terrain (a so-called all terrain vehicle, hereinafter simply referred to as an ATV).

2. Description of the Related Art

Wheels for use in this kind of vehicle are often made of aluminum or an aluminum alloy for the purpose of being made lightweight, and a variety of kinds thereof have been in mass production.

Examples of the most typical wheel among them include a wheel formed in such a manner that, as shown in Japanese Patent Application Laid-Open (Kokai) No. 62-166102 and the like, an inner rim i₁ and an outer rim o₁ are separately drawn into cup shape, a center plate c₁ is inserted between the drawn inner rim i₁ and outer rim o₁, and the three plates, the inner rim i₁, the outer rim o₁ and the center plate c₁, are simultaneously welded (3₁) so as to be integrated with one another (see FIG. 3, hereinafter referred to as Related Art 1).

Further, the above-described examples also include a wheel formed in the following manner: a plate made of aluminum or an aluminum alloy is roll-molded into cylindrical shape, abutted edges of this cylindrical shape are welded, this weld is subjected to, for example, trimming which is described in Japanese Patent No. 3954546, and thereafter, an inner/outer integrated rim io₂ is formed using a roll forming machine. Apart from this, a disk d₂ is drawn, and this disk d₂ is press-inserted into the rim io₂ and then welded (3₂) (see FIG. 4, hereinafter also referred to as Related Art 2).

Further, the above-described examples also include a wheel formed in the following manner, as shown in Japanese Patent Application Laid-Open (Kokai) No. 2005-14620: an inner rim i₃ and an outer rim o₃ are separately drawn into cup shape from a plate made of aluminum or an aluminum alloy, the drawn inner rim i₃ and outer rim o₃ are separately bottom-punched to finish the rim edges thereof. Apart from this, a disk d₃ is drawn, and the inner rim i₃ and the outer rim o₃ are press-inserted into this disk d₃ so that those three are welded (3₃) (see FIG. 5, hereinafter also referred to as Related Art 3).

Further, the above-described examples also include a wheel formed in the following manner, as shown in Japanese Patent Application Laid-Open (Kokai) No. 2007-14984: a portion with a large plate thickness to become a disk section d₄ is embossed and a portion with a small plate thickness is drawn to form a rim section, out of a material with a plate thickness varied such that a central portion is thick and a periphery thereof is thin, so as to form an outer rim o₄ with the rim section and the disk section d₄ integrated with each other, while an inner rim i₄ is formed by drawing, and this inner rim i₄ and the outer rim o₄ are welded (3₄) (see FIG. 6, hereinafter also referred to as Related Art 4).

The wheels for a vehicle produced according to above-described Related Arts 1 to 4, namely the wheels for a vehicle shown in FIGS. 3 to 6, respectively have advantages and disadvantages.

For example, according to the wheel w₁ for a vehicle and the production method thereof which are described in Related Art 1, the wheel has an advantage that a flange f₁ portion requiring the largest strength becomes strong since the flange f₁ portion requiring the largest strength is inward curled to have double shape and is further drawn so that a plate thickness of the flange f₁ portion can be made large. Moreover, the wheel also has an advantage of being a lightweight wheel having the largest strength since its internal stress can be held by drawing.

As opposed to this, the wheel has a disadvantage of being unable to freely design a disk d₁ portion since the disk d₁ portion is made up of three plates.

Further, according to the wheel w₂ for a vehicle and the production method thereof which are described in Related Art 2, since a disk d₂ portion is made up of one plate, the wheel has an advantage that not only free embossing can be performed but also its strength can be reinforced by embossing, and its design properties are excellent. Further, the wheel also has an advantage of having a good material yield.

As opposed to this, the wheel has a disadvantage that the process of inward curling a flange f₂ by roll-molding is difficult and the wheel is thus not dimensionally stabilized. Further, since its internal stress cannot be held by a process such as drawing, the wheel also has a disadvantage of requiring a rim member with a larger thickness. Moreover, the wheel also has a disadvantage of being heavy in weight.

Further, according to the wheel w₃ for a vehicle and the production method thereof which are described in Related Art 3, since the disk d₃ portion is made up of one plate, the wheel has an advantage that not only free embossing can be performed but also its design properties are excellent. Further, since both the inner rim i₃ and the outer rim o₃ can be formed by drawing, its internal stress can be held, and the wheel is thus an ideal wheel.

As opposed to this, the wheel has a disadvantage that many man-hours are required for processing an outer periphery of the disk d₃. Further, there is no other choice but to scrap all bottom-punched portions in the rim, thus leading to a poor yield.

Further, according to the wheel w₄ for a vehicle and the production method thereof which are described in Related Art 4, since the center plate is not necessary, the wheel has an advantage of having an improved yield. Further, since a disk d₄ portion can be made up of two plates, different from the disk portion made up of three plates as in Related Art 1, the wheel has an advantage of having significantly improved performance.

As opposed to this, the wheel has a disadvantage that the disk d₄ portion has insufficient design properties. Further, the wheel also has a disadvantage that it is not possible to expect weight saving due to increased strength of a thin-plate disk formed by embossing.

As thus described, the wheels w₁ to w₄ for a vehicle produced according to above-described Related Arts 1 to 4, namely the wheels for a vehicle shown in FIGS. 3 to 6, respectively have advantages and disadvantages.

### BRIEF SUMMARY OF THE INVENTION

The present invention was made so as to dissolve at least all the disadvantages that a wheel need to avoid by any means, out of the above-described advantages and disadvantages.

The wheel for a vehicle of the present invention comprises: an outer rim which includes a disk section formed by embossing a portion with a large plate thickness and a rim section formed by drawing a portion with a small plate thickness as a periphery of the disk section, out of a material with a plate thickness varied such that a central portion is thick and a periphery thereof is thin; and an inner rim which has a superimposed portion that is superimposed on a prescribed position of the disk section by drawing, characterized in that flange sections of both the outer/inner rims are formed in inward curled double shape, and the outer rim and the inner rim are integrated with each other by a weld in a state where the superimposed portion is superimposed and positioned on the prescribed position of the disk section.

This wheel for a vehicle has an advantage of comprising the strongest rim section since the flange section is formed in inward curled double shape. Further, the wheel has an advantage of having the degree of freedom of design since the disk section is made up of one plate. Moreover, since the disk section is formed by embossing, the wheel has an advantage that an increase in strength of the disk can be expected even when the disk is a thin plate, consequently giving an extremely lightweight wheel. Furthermore, the wheel has an advantage of also having a good material yield. Additionally, the wheel has an advantage of eliminating the need for finishing the rim edge.

Further, another wheel for a vehicle according to the present invention comprises: an inner rim which includes a disk section formed by embossing a portion with a large plate thickness and a rim section formed by drawing a portion with a small plate thickness as a periphery of the disk section, out of a material with a plate thickness varied such that a central portion is thick and a periphery thereof is thin; and an outer rim formed by drawing and bottom-punching and by edge-finishing, characterized in that flange sections of both the inner/outer rims are formed in inward curled double shape, and the outer rim is press-inserted into the inner rim and both rims are integrated with each other by a weld.

Another wheel for a vehicle according to the present invention requires finishing of the rim edge, but except for that, it has the similar advantages to those in the case of the above-described wheel for a vehicle.

Meanwhile, the method for producing a wheel for a vehicle according to the present invention is characterized in that a portion with a large plate thickness to become a disk section is embossed and a portion with a small plate thickness is drawn to form a rim section, out of a material with a plate thickness varied such that a central portion is thick and a periphery thereof is thin, so as to form an outer rim with the rim section and the disk section integrated with each other, while an inner rim provided with a superimposed portion superimposed on a prescribed position of the disk section is formed by drawing, flange sections of both the outer/inner rims are inward curled to form a double shape, and the outer rim and the inner rim are welded so as to be integrated with each other in a state where the superimposed portion is superimposed and positioned on the prescribed position of the disk section.

This method for producing a wheel for a vehicle has an advantage of comprising the strongest rim section since the flange section can be formed into inward curled double shape. Further, the wheel has an advantage of having the degree of freedom of design since the disk section is made up of one plate. Moreover, since the disk section is formed by embossing, the wheel has an advantage that an increase in strength of the disk can be expected even when the disk is a thin plate, consequently giving an extremely lightweight wheel. Furthermore, the wheel has an advantage of also having a good material yield. Additionally, the wheel has an advantage of eliminating the need for finishing the rim edge.

Further, another method for producing a wheel for a vehicle according to the present invention is characterized in that a portion with a large plate thickness to become a disk section is embossed and a portion with a small plate thickness is drawn to form a rim section, out of a material with a plate thickness varied such that a central portion is thick and a periphery thereof is thin, so as to form an inner rim with the rim section and the disk section integrated with each other, while an outer rim is formed by drawing, and bottom-punched for edge-finishing, the flange sections of both the inner/outer rims are inward curled to form a double shape, and the outer rim is press-inserted into the inner rim, and both rims are welded so as to be integrated with each other.

Another method for producing a wheel for a vehicle according to the present invention requires finishing of the rim edge, but except for that, it has the similar advantages to those in the case of the above-described method for producing a wheel for a vehicle.

The wheel for a vehicle according to the first aspect of the present invention has an advantage of comprising the strongest rim section since the flange section is formed in inward curled double shape. Further, the wheel has an advantage of having the degree of freedom of design since the disk section is made up of one plate. Moreover, since the disk section is formed by embossing, the wheel has an advantage that an increase in strength of the disk can be expected even when the disk is a thin plate, consequently giving an extremely lightweight wheel. Furthermore, the wheel has an advantage of also having a good material yield. Additionally, the wheel has an advantage of eliminating the need for finishing the rim edge.

The wheel for a vehicle according to the second aspect of the present invention requires finishing of the rim edge, but except for that, it has the similar advantages to those in the case of the wheel for a vehicle according to the first aspect of the present invention described above.

The method for producing a wheel for a vehicle according to the third aspect of the present invention has an advantage of comprising the strongest rim section since the flange section can be formed into inward curled double shape. Further, the wheel has an advantage of having the degree of freedom of design since the disk section is made up of one plate. Moreover, since the disk section is formed by embossing, the wheel has an advantage that an increase in strength of the disk can be expected even when the disk is a thin plate, consequently giving an extremely lightweight wheel. Furthermore, the wheel has an advantage of also having a good material yield. Additionally, the wheel has an advantage of eliminating the need for finishing the rim edge.

The method for producing a wheel for a vehicle according to the fourth aspect of the present invention requires finishing of the rim edge, but except for that, it has the similar advantages to those in the case of the method for producing a wheel for a vehicle according to the third aspect of the present invention described above.

### BRIEF DESCRIPTION OF THE SEVERAL VIEWS OF THE DRAWINGS

FIG. 1(a) is a front view of a wheel for a vehicle according to one embodiment of the present invention, FIG. 1(b) being a sectional view taken along the line 1b-1b in FIG. 1(a);

FIG. 2(a) is a front view of a wheel for a vehicle according to another embodiment of the present invention,

FIG. 2(b) being a sectional view taken along the line 2b-2b in FIG. 1(a);

FIG. 3(a) is a front view of a conventional wheel for a vehicle exemplified as Related Art 1, FIG. 3(b) being a sectional view taken along the line 3b-3b in FIG. 3(a);

FIG. 4(a) is a front view of a conventional wheel for a vehicle exemplified as Related Art 2, FIG. 4(b) being a sectional view taken along the line 4b-4b in FIG. 4(a);

FIG. 5(a) is a front view of a conventional wheel for a vehicle exemplified as Related Art 3, FIG. 5(b) being a sectional view taken along the line 5b-5b in FIG. 5(a); and

FIG. 6(a) is a front view of a conventional wheel for a vehicle exemplified as Related Art 4, FIG. 6(b) being a sectional view taken along the line 6b-6b in FIG. 6(a).

### DETAILED DESCRIPTION OF THE INVENTION

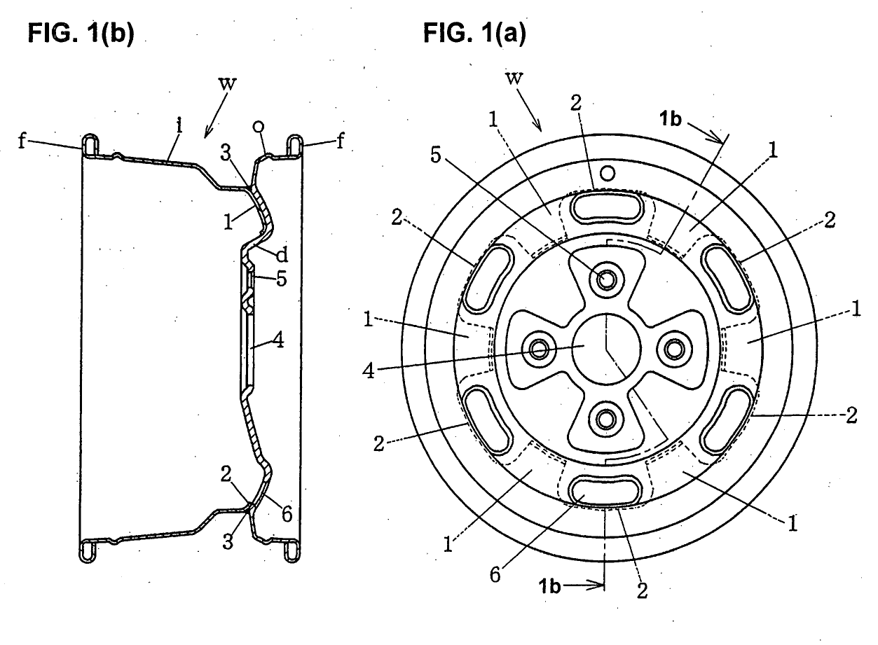

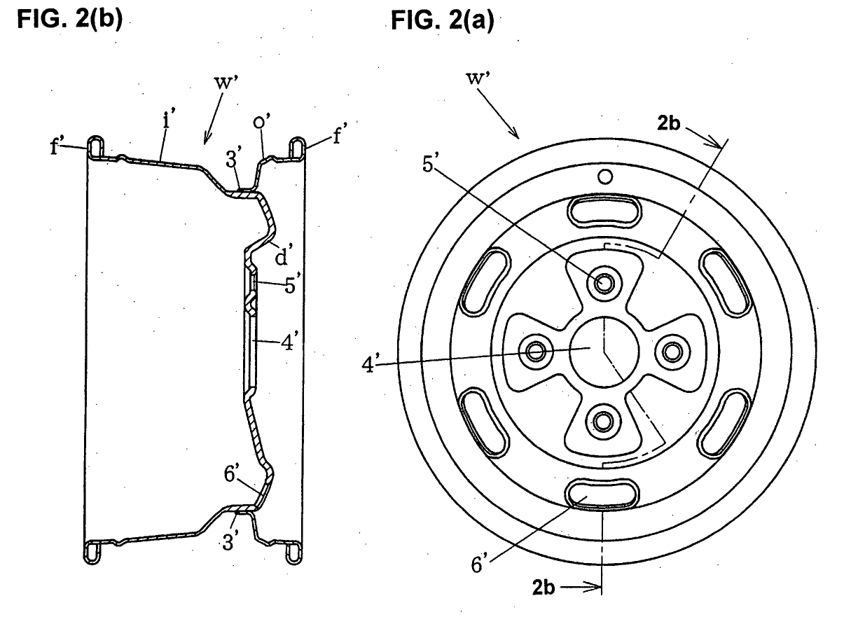

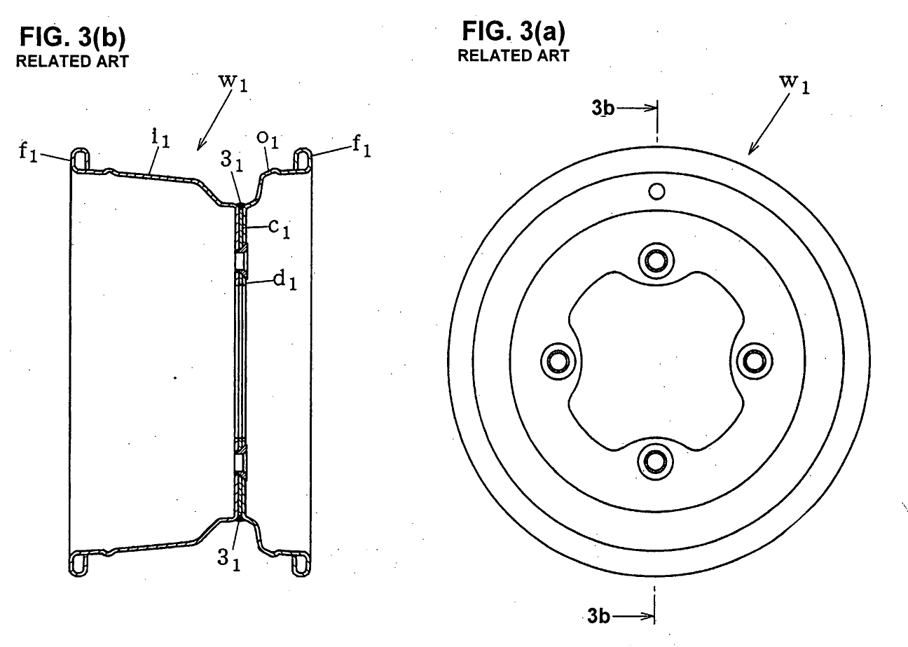

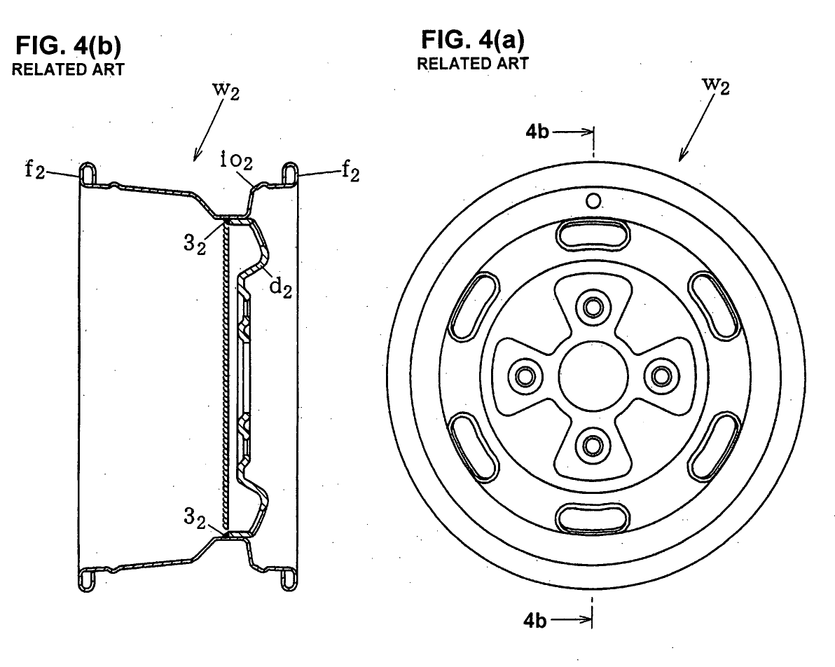

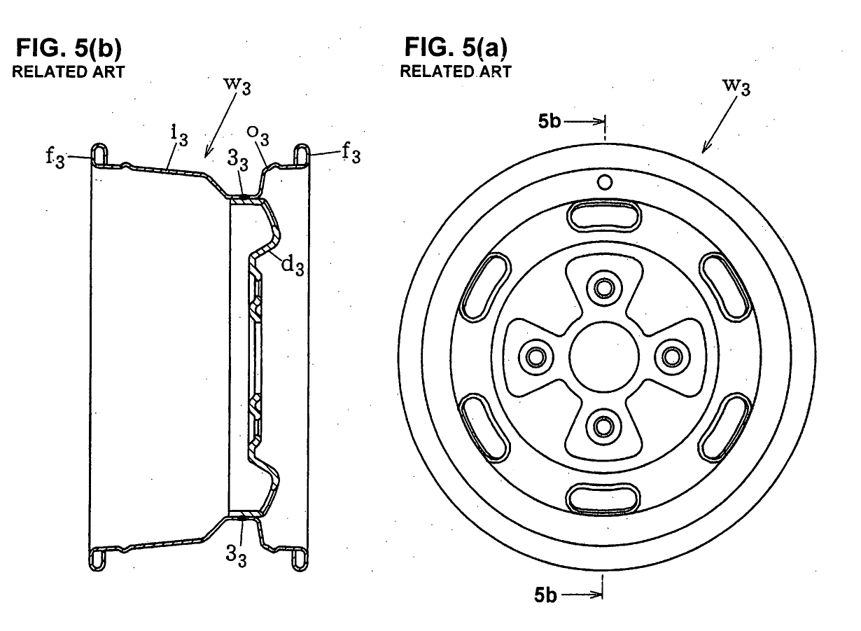

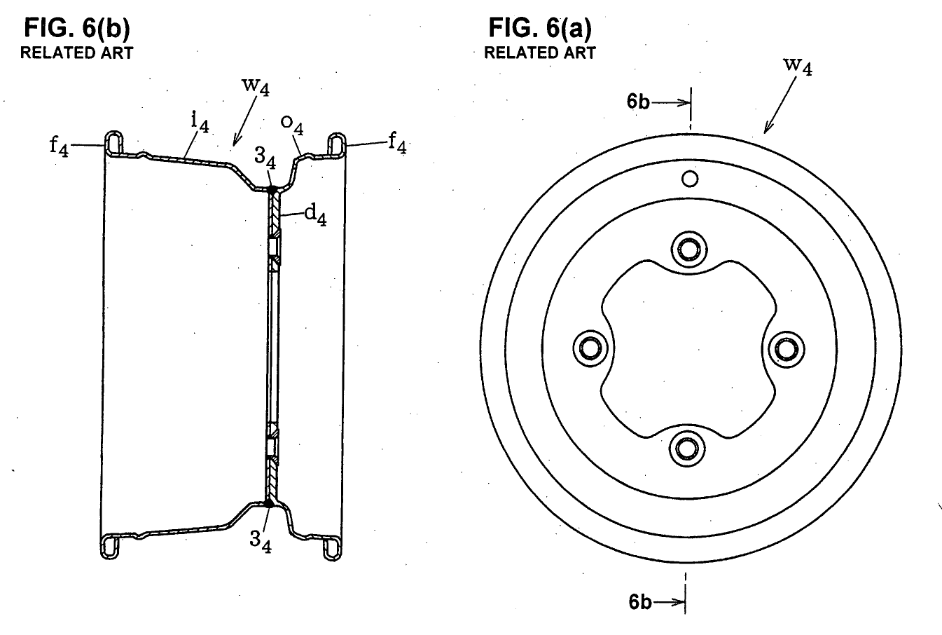

The best mode for carrying out the present invention is specifically described based upon FIGS. 1 and 2.

FIG. 1 shows an example of a wheel w for a vehicle which has an outer rim o including a disk section d formed by embossing a portion with a large plate thickness and a rim section formed by drawing a portion with a small plate thickness as a periphery of the disk section d, out of a material with a plate thickness varied such that a central portion is thick and a periphery thereof is thin.

As opposed to this, FIG. 2 shows another example of a wheel w′ for a vehicle which has an inner rim i′ including a disk section d′ formed by embossing a portion with a large plate thickness and a rim section formed by drawing a portion with a small plate thickness as a periphery of the disk section d′, out of a material with a plate thickness varied such that a central portion is thick and a periphery thereof is thin.

The wheel w for a vehicle shown in FIG. 1 is comprised of the outer rim o and an inner rim i which has superimposed portions 1, 2 superimposed on prescribed positions of the disk section d by drawing, and flange sections f, f of the outer rim and the inner rim i are formed in inward curled double shape. The outer rim o and the inner rim i are integrated with each other by a weld 3 in a state where the superimposed portions 1, 2 are superimposed and positioned on the prescribed positions of the disk section d. In order to form the flange sections f, f into inward curved double shape, a pressing system can be adopted.

Since the wheel w for a vehicle shown in FIG. 1 is configured as thus described, it has advantages as described below:

(1) Since the flange section f is formed in double shape inward curled by pressing, the wheel comprises the strongest rim section.

(2) Since the disk section d is made up of one plate, there is the degree of freedom of design.

(3) Since the disk section d is formed by embossing, an increase in strength of the disk can be expected even when the disk is a thin plate, consequently giving an extremely lightweight wheel.

(4) A good material yield is also obtained.

(5) The need for finishing the rim edge is eliminated.

As apparent from FIG. 1(a), the plurality of superimposed portions 1 are provided with even intervals in the circumferential direction of the wheel w for a vehicle, and other portions are notched. However, outer edge rims of the notched portions are configured so as to be slightly superimposed on the disk section d of the wheel w for a vehicle, and these portions are taken as the superimposed portions 2. The outer rim o and the inner rim i are then integrated with each other by the weld 3 in a state where the superimposed portions 1, 2 are superimposed and positioned on the prescribed positions of the disk section d.

Further, the wheel w′ for a vehicle shown in FIG. 2 is comprised of the inner rim i′ and an outer rim o′ formed by drawing and bottom-punching and by edge-finishing, and flange sections f′, f′ of the inner rim i′ and the outer rim o′ are formed in inward curled double shape. The outer rim o′ is press-inserted into the inner rim i′ and both rims are integrated with each other by a weld 3′. In order to form the flange sections f′, f′ into inward curved double shape, the pressing system can be adopted.

Since the wheel w′ for a vehicle shown in FIG. 2 is configured as thus described, the finishing of the rim edge is required, but except for that, it has the similar advantages to those in the case of the wheel w for a vehicle shown in FIG. 1. The advantages are described below:

(1) Since the flange section f′ is formed in double shape inward curled by pressing, the wheel comprises the strongest rim section.

(2) Since the disk section d′ is made up of one plate, there is the degree of freedom of design.

(3) Since the disk section d′ is formed by embossing, an increase in strength of the disk can be expected even when the disk is a thin plate, consequently giving an extremely lightweight wheel.

(4) A good material yield is also obtained.

Meanwhile, the wheel w for a vehicle shown in FIG. 1 can be produced in such a manner that a portion with a large plate thickness to become a disk section d is embossed and a portion with a small plate thickness is drawn to form a rim section, out of a material with a plate thickness varied such that a central portion is thick and a periphery thereof is thin, so as to form an outer rim o with the rim section and the disk section d integrated with each other, while an inner rim i provided with superimposed portions 1, 2 superimposed on prescribed positions of the disk section d is formed by drawing, flange sections f, f of both the outer rim o and the inner rim are inward curled to form a double shape, and the outer rim o and the inner rim i are welded (3) so as to be integrated with each other in a state where the superimposed portions 1, 2 are superimposed and positioned on the prescribed positions of the disk section d. In order to form the flange sections f, f into inward curved double shape, the pressing system can be adopted.

This production method has advantages as described below:

(1) Since the flange section f can be inward curled by pressing so as to have a double shape, the wheel comprises the strongest rim section.

(2) Since the disk section d is made up of one plate, there is the degree of freedom of design.

(3) Since the disk section d is formed by embossing, an increase in strength of the disk can be expected even when the disk is a thin plate, consequently giving an extremely lightweight wheel.

(4) A good material yield is also obtained.

(5) The need for finishing the rim edge is eliminated.

(6) As a result of the above, the most lightweight wheel can be obtained.

In addition, if a disadvantage of the wheel w for a vehicle shown in FIG. 1 and the production method thereof were to be cited, it may be that making a place for superimposing and positioning the superimposed portions 1, 2 on the prescribed positions of the disk section d is necessary, and that performing the positioning operation is necessary.

Further, the wheel w′ for a vehicle shown in FIG. 2 can be produced in such a manner that a portion with a large plate thickness to become a disk section d′ is embossed and a portion with a small plate thickness is drawn to form a rim section, out of a material with a plate thickness varied such that a central portion is thick and a periphery thereof is thin, so as to form an inner rim i′ with the rim section and the disk section d′ integrated with each other, while an outer rim o′ is formed by drawing, and bottom-punched for edge-finishing, flange sections f′, f′ of both the inner rim i′ and the outer rim o′ are inward curled to form a double shape, and the outer rim o′ is press-inserted into the inner rim i′, and both rims are welded (3′) so as to be integrated with each other. In order to form the flange sections ft, f′ into inward curved double shape, the pressing system can be adopted.

This production method requires the finishing of the rim edge, but except for that, it has the similar advantages to those in the case of the production method for the wheel w for a vehicle shown in FIG. 1. The advantages are described below:

(1) Since the flange section f′ can be inward curled by pressing so as to have a double shape, the wheel comprises the strongest rim section.

(2) Since the disk section d′ is made up of one plate, there is the degree of freedom of design.

(3) Since the disk section d′ is formed by embossing, an increase in strength of the disk can be expected even when the disk is a thin plate, consequently giving an extremely lightweight wheel.

(4) A good material yield is also obtained.

(5) As a result of the above, the most lightweight wheel can be obtained.

In addition, if a disadvantage of the wheel w′ for a vehicle shown in FIG. 2 and the production method thereof, other than the disadvantage that finishing of the rim edge is necessary, were to be cited, it may be that many man-hours are spent for processing the disk d′ since a wide range of the portion with a large plate thickness to become the disk section d′ is embossed out of the material with a plate thickness varied such that the central portion is thick and the periphery thereof is thin.

As thus described, according to the wheel w for a vehicle shown in FIG. 1 and the production method thereof and the wheel w′ for a vehicle shown in FIG. 2 and the production method thereof, it is possible to dissolve at least all the disadvantages out of the advantages and disadvantages of the wheels w₁ to w₄ for a vehicle and the production methods thereof which were described in above-described Related Arts 1 to 4.

In FIGS. 1 and 2, reference numerals 4, 4′ denote center holes, reference numerals 5, 5′ denote holes for wheel mounting, and reference numerals 6, 6′ denote holes punched so as to make the wheels w, w′ for a vehicle further lightweight. It should be noted that as in the conventional case, it is possible to fit the holes 5, 5′ for wheel mounting to a bolt (not shown) built in a hub (not shown) of an ATV and fix them using a tape nut (not shown), so as to mount the wheels w, w′ for a vehicle on the hub.

1. A wheel for a vehicle, comprising:
an outer rim which includes a disk section formed by embossing a portion with a large plate thickness and a rim section formed by drawing a portion with a small plate thickness as a periphery of the disk section, out of a material with a plate thickness varied such that a central portion is thick and a periphery thereof is thin; and
an inner rim which has a superimposed portion that is superimposed on a prescribed position of said disk section by drawing,
wherein
flange sections of both the outer/inner rims are formed in an inward curled double shape, and
said outer rim and said inner rim are integrated with each other by a weld in a state where said superimposed portion is superimposed and positioned on said prescribed position of said disk section.

2. A wheel for a vehicle, comprising:
an inner rim which includes a disk section formed by embossing a portion with a large plate thickness and a rim section formed by drawing a portion with a small plate thickness as a periphery of the disk section, out of a material with a plate thickness varied such that a central portion is thick and a periphery thereof is thin; and
an outer rim formed by drawing and bottom-punching and by edge-finishing,
wherein
flange sections of both the inner/outer rims are formed in an inward curled double shape, and
said outer rim is press-inserted into said inner rim and both rims are integrated with each other by a weld.

3. A method for producing a wheel for a vehicle, comprising the steps of:
forming an outer rim by embossing a portion with a large plate thickness so as to become a disk section and by drawing a portion with a small plate thickness so as to become a rim section, out of a material with a plate thickness varied such that a central portion is thick and a periphery thereof is thin, said rim section and said disk section being integrated with each other;
forming, by drawing, an inner rim provided with a superimposed portion superimposed on a prescribed position of said disk section;
inwardly curving flange sections of both of said outer/inner rims to form a double shape, and
welding said outer rim and said inner rim so as to be integrated with each other in a state where said superimposed portion is superimposed and positioned on said prescribed position of said disk section.

4. A method for producing a wheel for a vehicle, comprising the steps of:
forming an inner rim by embossing a portion with a large plate thickness so as to become a disk section and by drawing a portion with a small plate thickness so as to become a rim section, out of a material with a plate thickness varied such that a central portion is thick and a periphery thereof is thin, said rim section and said disk section of said inner rim being integrated with each other;
forming an outer rim by drawing, and bottom-punching said outer rim for edge-finishing,
inwardly curling flange sections of both of said inner/outer rims to form a double shape, and
press-inserting said outer rim into said inner rim, and welding both rims so as to be integrated with each other.
